(19) United States
(12) Patent Application Publication
(10) Pub. No.: US 2002/0056819 A1
(43) Pub. Date: May 16, 2002

(54) High-vacuum sealing gate valve with a single moving component

(76) Inventors: Joseph Contin, Alameda, CA (US); Jarall Wagner, Fremont, CA (US)

Correspondence Address: James E. Eakin, McDermott, Will & Emery, 3150 Porter Drive, Palo Alto, CA, 94304-1212, US

(21) Appl. No.: 09/964,982

(22) Filed: Sep. 26, 2001

Related U.S. Application Data
(60) Provisional application No. 60/235,786, filed on Sep. 26, 2000.

(51) Int. Cl. F16K 31/143

(52) U.S. Cl. 251/63

(57) ABSTRACT

A high vacuum valve assembly comprising a valve body with an air chamber formed therein. A gate unit is disposed within the air chamber and includes a valve gate portion disposed to mate to a valve seat, the valve gate portion and the valve seat portion each being disposed at the same angle to provide increased sealing force. The gate unit is urged into closure against the valve seat by a first tension source, which may be a spring, and away from the valve seat by a second tension source, which may be compressed gas, such that the gate unit comprises the only moving part of the valve.

### BACKGROUND OF THE INVENTION

High vacuum valves are widely used in the high technology industry. Most of the models that are available comprise several moving components, such as wheels, fulcrums, bearings and linkages. These mechanical components experience substantial friction caused by the rapid cycling of the valve encountered during normal operation. The wear of these components is a major source of particulate contaminants, such as metal debris, which affects adversely the production of materials such as integrated circuits and semiconductors, whose effectiveness and usefulness are closely related to the purity of their components. The presence of multiple mechanical parts also increases the complexity of the structure, hinders the accessibility to the individual parts, and hinders the overall maintenance of the valve.

The function of known valves is generally accomplished by a linkage-locking device, which relies on the alignment/unalignment of the valve shaft and the link, on and off center, along a common axis. The force required for the functioning of such a piston valve is considerable and causes the entire valve unit to shake and vibrate vigorously.

### FIGURES

FIG. 1 is a cross-sectional view of an exemplary embodiment of a valve assembly in accordance with the present invention

FIG. 2 is a partial cross-sectional view of the embodiment of FIG. 1 but rotated relative thereto.

FIG. 3 is a bottom view of the valve assembly of FIG. 1.

### DESCRIPTION OF THE INVENTION

The valve of the present invention is designed for use in high vacuum applications, such as thin film coating and the manufacture of integrated circuits on silicon wafers. The present invention is a high-vacuum sealing gate valve, which operates by the vertical movement of a single moving part, a gate unit. The importance of a single moving part is underscored by the minimal wear of a single mechanical part, which reduces particle contamination.

In an exemplary embodiment, the valve is closed by spring pressure that forces a piston of the gate unit downward to drive the gate unit to seal the flow channels. In an exemplary embodiment, the valve is opened by air pressure, which pushes the underside of the piston to drive the gate unit upward to open the seal of the flow channel. In an exemplary embodiment, there is no lateral movement of the stem. This mode of operation eliminates the noise normally created by the linkage and vibrations that are typical of the most widely used linkage carriage and gate type valves that use over center locking mechanisms.

In an exemplary embodiment, the invention is configured to provide a high vacuum sealing gate valve, which includes a single moving component.

In an exemplary embodiment, the invention is configured to minimize the amount of particulate contamination during manufacturing processes, which occur under high vacuum.

In an exemplary embodiment, the invention is configured to provide a gate valve, whose few parts are readily accessible and more easily maintained, thus rendering the valve unit more durable and more easily manufactured.

In an exemplary embodiment, the invention is configured to provide a gate valve constructed of materials which allow for the use of metal bushings and which obviate the use of bellows, thus keeping the movement of the valve silent and vibration free.

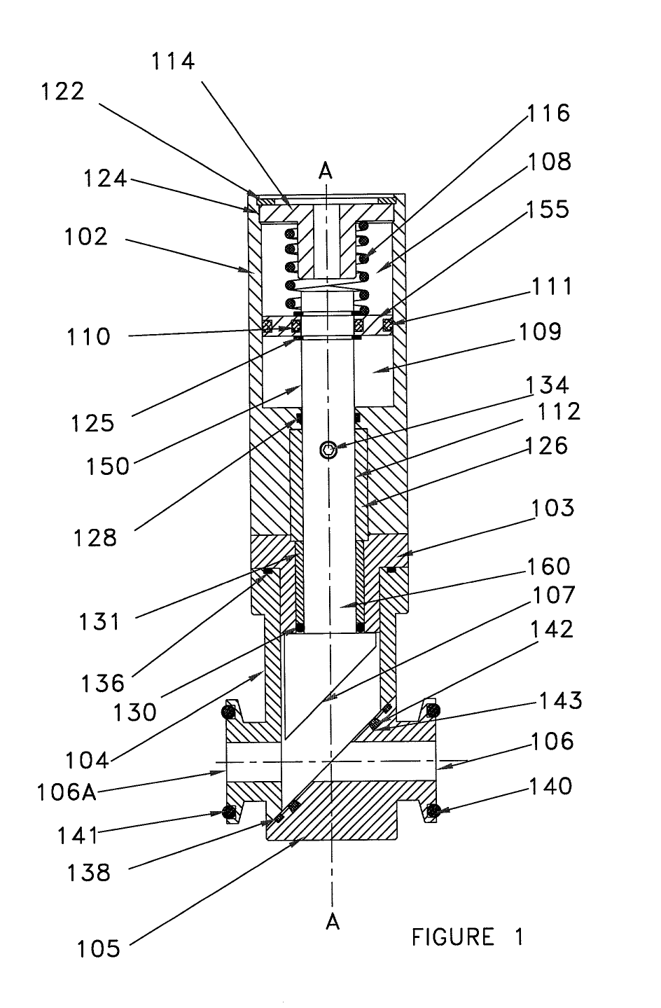

FIGS. 1, 2, and 3 show different aspects of the high-vacuum valve in an exemplary embodiment of the present invention. In an exemplary embodiment, the valve includes a valve assembly and a gate unit 150.

### General

FIG. 1 shows a longitudinal section through a high vacuum gate valve in an exemplary embodiment of the present invention. The valve is depicted in the open state. In an exemplary embodiment, the valve assembly includes a housing comprised of an air cylinder 102, a bonnet 103, a valve body 104, and a valve seat 105. In an exemplary embodiment, air cylinder 102, bonnet 103, valve body 104 and valve seat 105, are rigidly connected to each other to define an interior space which encloses the gate unit 150. In an exemplary embodiment, valve seat 105 and valve body 104 define a right flow channel 106 and a left flow channel 106A, respectively, for the passage of process flow.

In an exemplary embodiment, gate unit 150 is, in vacuum, the only movable component of the valve. In an exemplary embodiment, gate unit 150 includes a piston 155, which is unitary with a valve stem 160, which, in turn, is unitary with the valve gate 165. Valve gate 165 may be fixedly attached to valve stem 160. Alternatively, valve gate 165 and valve stem 160 may be machined as an integral unit. In an exemplary embodiment, as shown in FIG. 1, valve seat 105 provides a first sealing surface 170, which is machined at an angle with respect to center line A-A that is equal to the angle with respect to center line A-A at which a second sealing surface 107 of the valve gate 165 is machined. In an exemplary embodiment, first sealing surface 170 and second sealing surface 107 are machined at 45° angles with respect to center line A-A. In an exemplary embodiment first sealing surface 170 and second sealing surface 107 are machined at equal angles with respect to center line A-A, where the angles range from 0 degrees to 75 degrees.

In an exemplary embodiment, as shown in FIG. 1, air cylinder 102 and piston 155, define an upper air chamber 108 and a lower air chamber 109, which are sealed from each other by a first O-ring 110 and a second O-ring 111. Air cylinder 102 also defines a cylindrical passage 112. Air chambers 108 and 109 enclose actuation components of the valve. In an exemplary embodiment, the actuation components of the valve include an air cylinder cap 114, a spring member 116, and piston 155.

In an exemplary embodiment, as shown in FIG. 1, air cylinder cap 114 is mushroom-shaped and serves to cap air cylinder 102. In an exemplary embodiment, air cylinder 102 is spring activated by spring member 116. A retaining ring 122 and air cylinder cap 114 are easily removed to allow for effortless access to the other components of the valve. In an exemplary embodiment, a second retaining ring 125 holds piston 155 at a fixed position relative to stem 160.

In an exemplary embodiment, as shown in FIG. 1, the upper portion of spring member 116 surrounds the narrow portion of air cylinder cap 114 and faces the interior side of cylinder cap 114, while the lower part of spring member 116 surrounds the uppermost portion of valve stem 160 and faces the upper side of piston 155. In an exemplary embodiment, spring member 116 is biased toward closing the valve and functions to maintain valve gate 165 in a closed position by preventing the upward movement of valve stem 160 in the event of a sudden loss of air pressure.

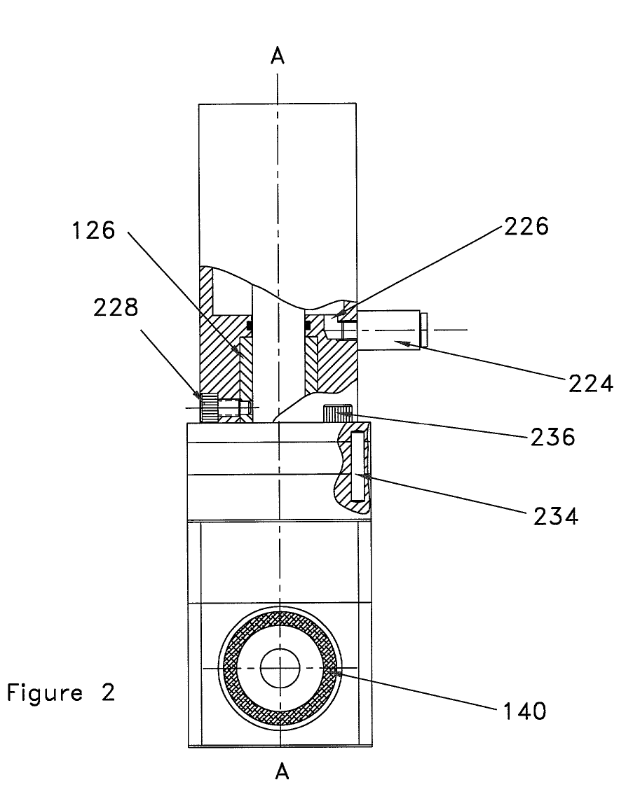

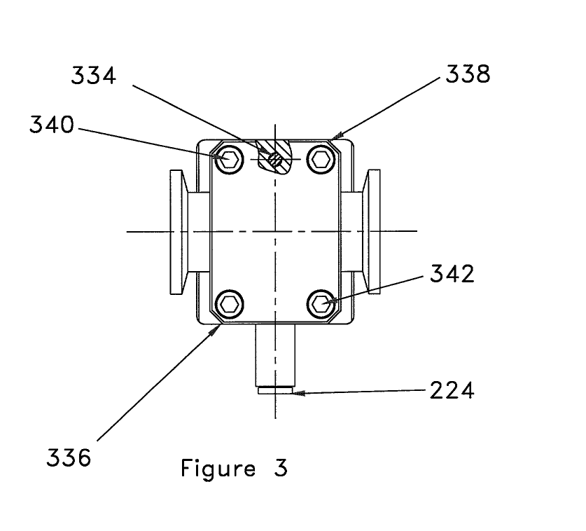

FIG. 2 is a partly sectional view along center line A-A of the gate valve shown in FIG. 1, where the valve is turned counterclockwise by 90° relative to the exemplary embodiment shown in FIG. 1. In an exemplary embodiment, an air fitting 224 is present on the exterior of air cylinder 102, to provide air to lower air chamber 109 via an air duct 226. The position of air fitting 224 relative to the other components of the valve is also shown in FIG. 3. FIG. 3 is a view of the invention seen from the underside of the gate valve in an exemplary embodiment of the present invention.

In an exemplary embodiment, as shown in FIG. 1, air chamber 109 extends into narrow cylindrical passage 112 through which stem 160 of gate unit 150 moves during the operation of the valve. In an exemplary embodiment, as shown in FIGS. 1 and 2, a low friction guide bushing 126 extends longitudinally to line cylindrical passage 112. In an exemplary embodiment, as shown in FIG. 2, bushing 126 is secured in position by first fasteners 228 which extend from the outer surface of air cylinder 102 through the wall of air cylinder 102 and partially into guide bushing 126. In an exemplary embodiment, first fasteners 228 are screws.

In an exemplary embodiment, as shown in FIG. 1, a (1) third O-ring 128 and (2) a fourth O-ring 130 and a lower bushing 131, surround stem 160 at positions above and below bushing 126, respectively, to maintain the pressure or vacuum as stem 160 moves upward or downward. Cylindrical passage 112 extends through bonnet 103 and into a valve body chamber 132.

In an exemplary embodiment, as shown in FIG. 1, a guide pin 134 aligns stem 160 to be perpendicular to valve seat 105.

In an exemplary embodiment, as shown in FIG. 2, air cylinder 102 is rigidly attached to bonnet 103 by second fasteners 236. In an exemplary embodiment, second fasteners 236 are screws. In an exemplary embodiment, as shown in FIG. 2, a first pin 234 spans the thickness of bonnet 103 and anchors bonnet 103 to air cylinder 102 and valve body 104, thus preventing axial rotation of these components about each other. In an exemplary embodiment, a fifth O-ring 136 completes the seal between bonnet 103 and valve body 104.

In an exemplary embodiment, as shown in FIG. 1, the lowermost portion of the valve assembly includes valve body 104 and valve seat 105. In an exemplary embodiment, as shown in FIG. 3, a second pin 334 aligns valve seat 105 with valve body 104.

In an exemplary embodiment, as shown in FIG. 1, valve body chamber 132 houses valve gate 165. In an exemplary embodiment, as shown in FIG. 1, valve body 104 defines left flow channel 106A. In an exemplary embodiment, as shown in FIG. 1, valve seat 105 defines right flow channel 106. In an exemplary embodiment, as shown in FIG. 1, valve seat 105 provides sealing surface 170 which interfaces with sealing surface 107 to close the valve.

In an exemplary embodiment, as shown in FIGS. 1 and 3, valve body 104 is secured to valve seat 105 by third fastener 336, fourth fastener 338, fifth fastener 340, and sixth fastener 342. In an exemplary embodiment, third fastener 336 is a screw. In an exemplary embodiment, fourth fastener 338 is a screw. In an exemplary embodiment, fifth fastener 340 is a screw. In an exemplary embodiment, sixth fastener 342 is a screw.

In an exemplary embodiment, fasteners 336, 338, 340, and 342 and a sixth O-ring 138 seal the interior environment of the valve chamber. In an exemplary embodiment, a seventh O-ring 140 may seal connections to right flow channel 106, which may be attached to the valve assembly. In an exemplary embodiment, an eighth O-ring 141 may seal connections to left flow channel 106A, which may be attached to the valve assembly.

In an exemplary embodiment, the components of the valve, except for the O-rings, bushings, the spring member, and fasteners, are constructed of aluminum. In an exemplary embodiment, the components of the valve, except for the O-rings, bushings, the spring member, and fasteners, are constructed of refined aluminum. In an exemplary embodiment, the components of the valve, except for the O-rings, bushings, the spring member, and fasteners, are constructed of AL6061-T6. In an exemplary embodiment, the components of the valve, except for the O-rings, bushings, the spring member, and fasteners, are constructed of 2011 aluminum.

In an exemplary embodiment, the components of the valve, except for the O-rings, bushings, the spring member, and fasteners, are electropolished. The electropolishing helps to keep these components clean.

In an exemplary embodiment, the O-rings are constructed of materials which is suitable for ultra-high vacuum (UHV). In an exemplary embodiment, the O-rings are constructed of elastomer seals which are suitable for ultra-high vacuum (UHV). In an exemplary embodiment, one or more of the O-rings are constructed of VITON. In an exemplary embodiment, one or more of the O-rings are constructed of KALREZ. In an exemplary embodiment, O-rings 110, 111, and 128 are constructed of VITON. In an exemplary embodiment, O-rings 130, 136, 138, 140, and 142 are constructed of KALREZ.

In an exemplary embodiment, bushings 126 and 131 are constructed of bronze. In an exemplary embodiment, bushings 126 and 131 are constructed of phosphor bronze. In an exemplary embodiment, bushings 126 and 131 are constructed of other bearing surface material. In an exemplary embodiment, bushings 126 and 131 are constructed of composite PTFE.

In an exemplary embodiment, spring member 116 is constructed of music wire.

In an exemplary embodiment, the fasteners are constructed of stainless steel. In an exemplary embodiment, the fasteners are constructed of 304 SS.

### Valve Actuation

Actuation of the valve occurs via the movement of gate unit 150 within the valve assembly.

### Opening the Valve

The state of the gate valve shown in FIG. 1 is the state in which the valve is open. In an exemplary embodiment, as shown in FIGS. 1, 2, and 3, the valve is opened by supplying compressed air through air fitting 224, along air duct 226, and into lower air chamber 109. In an exemplary embodiment, the compressed air pushes the underside of piston 155 in an upward direction along with stem 160 and valve gate 165. In an exemplary embodiment, this movement (1) resiliently deforms spring member 116 against its restoration force pushing against air cylinder top 114 and (2) separates valve gate 165 from valve seat 105 to allow flow through flow channels 106 and 106A.

### Closing the Valve

In an exemplary embodiment, the straight movement of gate unit 150 in a direction closing flow channel 106 and 106A is achieved by decompressing spring member 116 to its normal state. In an exemplary embodiment, the decompressing of spring member 116 to its normal state forces the movement of piston 155, stem 160, and valve gate 165 in a downward direction. In an exemplary embodiment, flow channels 106 and 106A are sealed by the pressure exerted by first sealing surface 107 on a ninth O-ring 142 present on second sealing surface 170.

In an exemplary embodiment, O-ring 142 is not vulcanized onto the valve seat 105. In an exemplary embodiment, O-ring 142 is held in place by a dovetail groove 143 provided on the angled surface of valve seat 105, although any suitable method of maintaining this and the remaining O-rings in position will be acceptable in at least some embodiments.

In an exemplary embodiment, the force of the downward movement of gate unit 150 is amplified by the wedge effect at the interface of sealing surfaces 107 and 170, thereby providing a well-secured seal. In an exemplary embodiment, in the event of a sudden loss of air pressure, the closed position of the valve is maintained by the force of spring member 116 against the upper side of piston 155.

In an exemplary embodiment, air is the actuating medium and is used to drive gate unit 150. In an alternative embodiment, a gas, other than air, is the actuating medium and is used to drive gate unit 150. In an alternative embodiment, dry nitrogen is the actuating medium and is used to drive gate unit 150.

The gate valve of the present invention makes high-speed movement of valve gate 165 possible. The simple up/down movement of gate unit 150 makes the operation of this valve reliable, silent and smooth.

### Conclusion

The present invention relates to a valve apparatus for high-pressure differential/vacuum environments. More particularly, the invention relates to a high-vacuum gate valve with a single moving component.

Having filly described a preferred embodiment of the invention and various alternatives, those skilled in the art will recognize, given the teachings herein, that numerous alternatives and equivalents exist which do not depart from the invention. As a result, the invention is not to be limited by the foregoing description, but only by the appended claims.

What is claimed is:

1. A high vacuum valve assembly having
a housing including an air cylinder and a valve seat,
a gate unit positioned to move within the air cylinder and to seat again the valve seat when in a closed position, and disposed away from the valve seat when in an open position, the gate unit and valve seat having mating surfaces each disposed at the same angle,
first tension source for urging the gate unit away from the valve seat when the valve assembly is to be opened, and
second tension source for urging the gate unit toward the valve seat when the valve assembly is to be closed.

2. The high vacuum valve assembly of claim 1 wherein
the gate unit includes a piston, gate stem and valve gate.

3. The high vacuum valve assembly of claim 2 wherein the gate unit is formed as a single unit.

4. The high vacuum valve assembly of claim 2 wherein the piston, gate stem and valve gate form an integrated unit.

5. The high vacuum valve assembly of claim 1 wherein the first tension source is compressed gas.

6. The high vacuum valve assembly of claim 1 wherein the second tension source is a spring.

7. The high vacuum valve assembly of claim 1 wherein the angle is in the range of zero degrees to seventy-five degrees.

8. The high vacuum valve assembly of claim 1 wherein the angle is in the range of thirty degrees to seventy-five degrees.
